(19) United States
(12) Patent Application Publication
(10) Pub. No.: US 2015/0345698 A1
(43) Pub. Date: Dec. 3, 2015

(54) ADJUSTABLE MAGNETIC HOLDER FOR A PLURALITY OF WORK IMPLEMENTS

(71) Applicant: Thomas L. Klamm, Racine, WI (US)

(72) Inventor: Thomas L. Klamm, Racine, WI (US)

(21) Appl. No.: 14/287,859

(22) Filed: May 27, 2014

(51) Int. Cl. F16M 13/02

(52) U.S. Cl. CPC F16M 13/022

(57) ABSTRACT

A work implement holder includes a base with a permanent magnet and a first coupling. An elongated, flexible first shaft has a second coupling at one end that releasably mates with the first coupling to secure the first shaft to the base. A third coupling is attached to the second end of the first shaft. An elongated, flexible second shaft has an fifth coupling at one end that releasably mates with the third coupling to secure the second shaft to the first shaft. The opposite end of the second body has a sixth coupling. A work implement has a fourth coupling that releasably mates with the third and sixth couplings to secure the work implement to the first and second shafts, respectively. For example, the work implement can be a mirror, a magnifying glass, a clip, a permanent magnet, or a threaded connector.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to devices for hands-free holding of implements used by a worker, and particularly to such devices that are held in place by a magnetic base and are user adjustable to place an implement in a plurality of positions with respect to the base.

2. Description of the Related Art

Mechanics and other technicians frequently need to hold an object or a work implement at a certain position with respect to a workpiece while keeping both hands free for other tasks. For example, a worker may desire to view a work area through a magnifying glass while being able to use both hands to manipulate tools. This may be difficult where the work area is located on a large machine.

A device for holding the work implement must be able to be attached to the machine and be adjustable to position the work implement in the proper place with respect to the work area. The location at which the device can be mounted to the machine may be a wide range of distances from the work area. It also is desirable to permit the same device to hold variety of work implements depending on the task to be performed and to enable the worker to easily change the work implement being held.

### SUMMARY OF THE INVENTION

A work implement holder includes a base with a permanent magnet and a first coupling. A first shaft has an elongated, flexible first body with first and second ends. A second coupling is attached to the first body at the first end and releasably mates with the first coupling to secure the first shaft to the base. A third coupling is attached to the second end of the first body.

A work implement has a fourth coupling that releasably mates with the third coupling to attach the work implement to the second end of the first body of the first shaft. The fourth coupling also can releasably mate with the first coupling.

A second shaft has an elongated, flexible second body with one end at which a fifth coupling is secured. The fifth coupling releasably mates with the third coupling to attach the second shaft to the first shaft. The second body has another end at which is affixed a sixth coupling that releasably mates with the fourth coupling to attach the work implement to the second shaft.

In one embodiment, the first and second shafts of the work implement holder have a metal core with an exterior coating. For example, the metal of the core can be lead, zinc, copper, aluminum, iron, steel, or alloys thereof; and the exterior coating can be plastic, rubber, or polymer foam.

For example, the work implement may be a mirror, a magnifying glass, a clip, a permanent magnet, or a threaded shaft for attaching an object thereto.

### BRIEF DESCRIPTION OF THE DRAWINGS

FIG. 1 is a perspective view of a work implement holder according to the present invention;

FIG. 2 is a bottom view of a base of the work implement holder without a protective covering;

FIG. 3 is a bottom view of the base with a protective covering;

FIG. 4 illustrates an alternative base;

FIG. 5 is an exploded perspective view of two couplings that mate to connect components of the work implement holder;

FIG. 6 is an extension shaft for the work implement holder;

FIG. 7 is an alligator clip type work implement;

FIG. 8 is an permanent magnet type work implement; and

FIG. 9 is a perspective view of a work implement with a threaded shaft for attaching an object to the work implement.

### DETAILED DESCRIPTION OF THE INVENTION

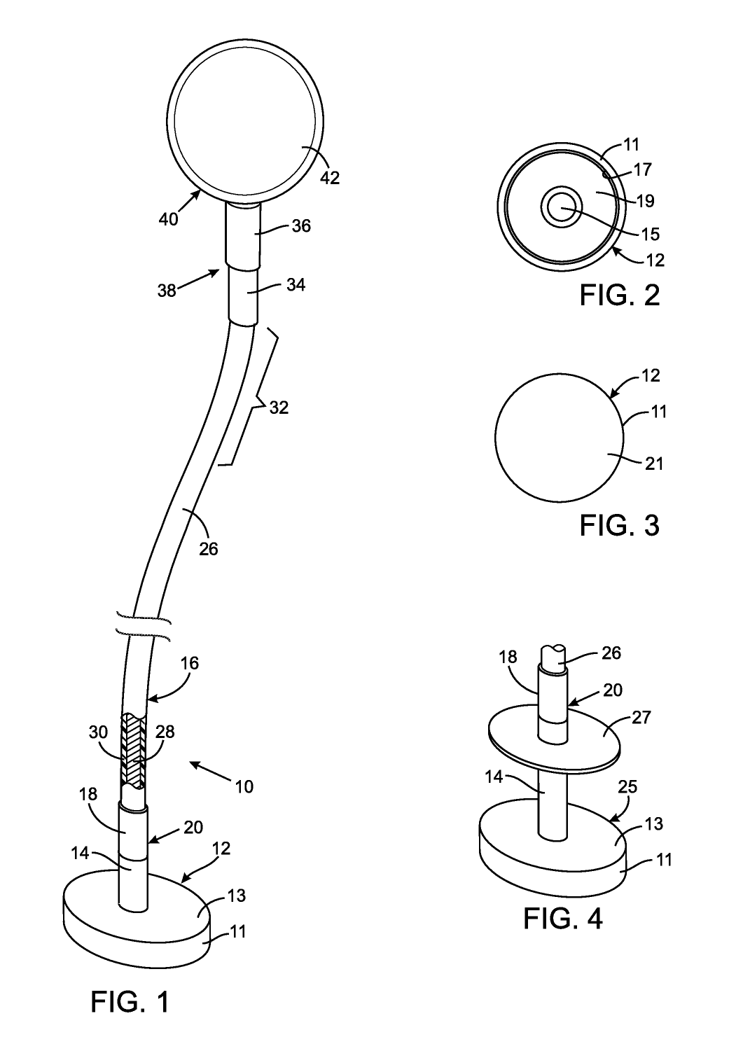

With initial reference to FIG. 1, a work implement holder 10 comprises a base 12 that has a disk-shaped base member 11 with a major surface 13 from which a first coupling 14 projects. For example, the first coupling 14 may attached by a bolt that extends through a hole in the base member 11 and is threaded into one end of the first coupling, or that end may have a short rod 15 projecting therefrom through the hole in the base member 11 and then peened against the bottom of the base member as shown in FIG. 2. Alternatively, the base member 11 and first coupling 14 can be integrated into a single piece. The body of the first coupling 14 may be longer than as depicted in the drawing or alternatively can be mounted to a projection that extends from the major surface 13 of the base member 11.

As seen in FIG. 2, the bottom side of the base member 11, opposite major surface 13, has a circular recess 17. An annular permanent magnet 19 is affixed in the recess 17 and extends around the peened end of rod 15 that projects through the central aperture in the base member. The bottom of the base member 11 may be left open as shown or as seen in FIG. 3, the bottom may be covered by a sheet 21 of magnetically transparent material, such as paper or plastic. The magnetic base 12 enables the work implement holder 10 to be releasably attached to a metal object adjacent the work area.

FIG. 4 depicts an alternative base 25 in which a disk 27 has an aperture through which the cylindrical first coupling 14 extends and is affixed therein, such as by welding to the disk for example. The disk 27 is spaced from the base member 11. This provides a gap between the disk 27 and the base member 11 within which the user can insert a pair of fingers to aid in pulling the magnetic base from a metal object adjacent the work area.

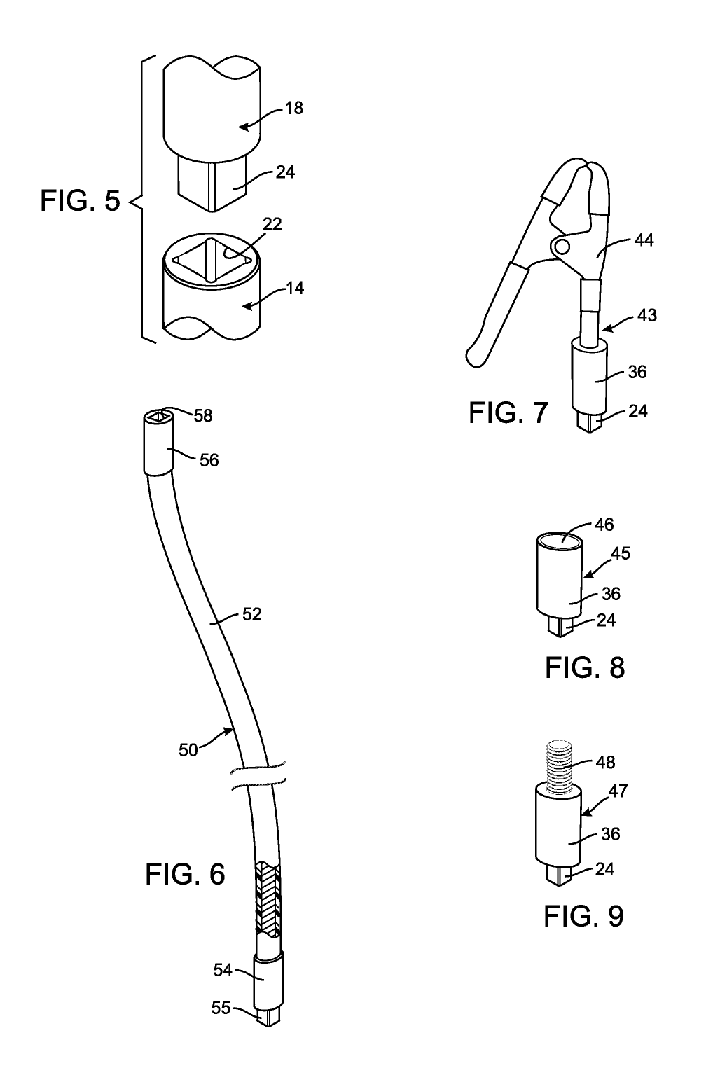

Referring again to FIG. 1, a flexible first shaft 16 includes an elongated first flexible body 26 that has a proximate end affixed to a second coupling 18 which mates with the first coupling 14. The first and second couplings 14 and 18 form a first connector 20. The first connector 20 may comprise any one of several conventional quick release connectors. For example, as shown in FIG. 5, the first coupling 14 is a socket with an aperture 22 therein that has a square cross section and the second coupling 18 has a square shank 24 that fits into the aperture 22 in the first coupling to thereby secure the two couplings together. That connection releasably attaches the first shaft 16 to the base 12. In a variation of the first connector 20, the aperture 22 can be formed directly in the base 12. Alternatively, the first coupling 14 may have the square shank 24 and the second coupling 18 may have the square aperture 22 to receive the square shank. The aperture 22 and the shank 24 may have other cross sectional shapes. Other types of releasable connectors may be used to attach the flexible shaft 16 to the base 12. As used herein, “releasable” and “releasably mates with” mean that the related components that are attached together can be detached by hand without using any tool and without having to disassemble or unfasten other components.

The first flexible body 26, for example, has a solid core 28 of a metal, such as lead, zinc, copper, aluminum, iron, steel, or alloys thereof, with an exterior coating 30 of plastic or rubber which provides an outer surface that will not mar objects in the work area. Optionally, the entire exterior coating 30 or at least a section 32 proximate to the distal end of the first shaft 16 may be a polymer foam that provides a cushion for gripping the first shaft. Other types of shafts, such as one with a stranded core or an uncoated core may be used. Although the shaft 16 is malleable by hand, it is sufficiently stiff to retain the orientation of a work implement 40 that is attached thereto. Of primary consideration is that the shaft 16 possess characteristics of being shapeable by hand, retaining such formed shape, holding a work implement without changing shape, and capable of being reshaped repeatedly without substantial weakening over a reasonable amount of normal use.

The distal end of the flexible shaft 16, that is remote from the base 12, has a third coupling 34 fastened thereto. The third coupling 34 is part of a second connector 38 that includes a fourth coupling 36 which releasably mates with the third coupling. The third and fourth couplings 34 and 36 have mating elements that are identical to the first and second couplings 14 and 18, respectively, i.e., the third coupling 34 has a square aperture and the fourth coupling 36 has a square shank that fits into that aperture.

The fourth coupling 36 is attached to a work implement 40, such as a mirror or magnifying glass 42 shown in FIG. 1. FIG. 7 shows an alligator clip 44 as the work implement 43 and in FIG. 8 the work implement 45 is a permanent magnet 46. FIG. 9 depicts a work implement 47 that has a threaded shaft 48 for attaching an object thereto. One skilled in the art will appreciate from the description herein that a wide variety of devices, such as a camera, can be releasably attached to the distal end of the flexible shaft 16. Another work implement may have a distal end covered with a non-sliding material, for example a dimpled plastic elastomer that has an extremely high coefficient of friction such as Egrips® manufactured by Flexible Innovations Ltd. in Fort Worth, Tex., U.S.A. Referring again to FIG. 1, the magnetic bottom surface of the base 12 can be attached to a metal object adjacent the work area and then the first shaft 16 can be bent to position the work implement 40 at the desired location with respect to that work area. The magnetic attachment allows the work implement holder 10 to be easily removed from the metal object when no longer needed.

With reference to FIG. 6, a flexible second shaft 50 is provided to extend the length of the work implement holder 10. The second shaft 50 comprises an elongated, flexible second body 52 with a fifth coupling 54 at one end, wherein that coupling is identical to the second coupling 18, e.g., the fifth coupling has a square shank 55. A sixth coupling 56 is attached to the other end of the second body 52 and is identical to the third coupling 34, e.g., the sixth coupling has a square aperture 58. This coupling arrangement enables the square shank 55 of the fifth coupling 54 to be inserted into the square aperture in the third coupling 34 in place of the work implement 40 shown in FIG. 1. That work implement 40 then can be inserted into the square aperture 58 in the sixth coupling 56. Thus the combination of the two flexible shafts 16 and 50 increases the overall length of the work implement holder 10. The flexible first and second shafts 16 and 50 may have the same or different individual lengths.

The foregoing description is primarily directed to one or more embodiments of the invention. Although some attention has been given to various alternatives within the scope of the invention, it is anticipated that one skilled in the art will likely realize additional alternatives that are now apparent from disclosure of embodiments of the invention. Accordingly, the scope of the invention should not limited by the above disclosure.

1. A work implement holder comprising:
a base comprising a permanent magnet and a first coupling;
a first shaft comprising an elongated, flexible first body having a first end at which is secured a second coupling that releasably mates with the first coupling to attach the first shaft to the base, and a third coupling is secured to a second end of the first body;
a work implement having a fourth coupling that releasably mates with the third coupling to secure the work implement to the first shaft; and
a second shaft having an elongated, flexible second body with one end at which is secured a fifth coupling that releasably mates with third coupling to attach the second shaft to the first shaft, the second body has another end at which is affixed a sixth coupling that releasably mates with the fourth coupling to attach the work implement to the second shaft.

2. The work implement holder as recited in claim 1 wherein the first body comprises an elongated metal member.

3. The work implement holder as recited in claim 1 wherein the first body comprises an elongated metal core with an exterior coating.

4. The work implement holder as recited in claim 3 wherein the metal core is composed of metal selected from the group consisting of lead, zinc, copper, aluminum, iron, steel, and alloys thereof.

5. The work implement holder as recited in claim 3 wherein the exterior coating is composed of a material selected from the group consisting of plastic, rubber, and polymer foam.

6. The work implement holder as recited in claim 1 wherein the first, third and sixth couplings have an aperture; and the second, fourth and fifth couplings have a shank that is receivable in the aperture.

7. The work implement holder as recited in claim 1 wherein the second, fourth and fifth couplings have an aperture; and the first, third and sixth couplings have a shank that is receivable in the aperture.

8. The work implement holder as recited in claim 1 wherein the work implement is one of a mirror, a magnifying glass, a clip, and a permanent magnet.

9. The work implement holder as recited in claim 1 wherein the work implement has a threaded shaft for attaching an object thereto.

10. The work implement holder as recited in claim 1 further comprising a disk mounted to the first coupling and spaced from a surface of the base.

11. A work implement holder comprising:
a base having a permanent magnet for attaching the base to an object and having a first coupling;
a first shaft with an elongated, flexible first body comprising a metal core with an exterior coating, the first body having a first end at which is affixed a second coupling that releasably mates with the first coupling to attach the first shaft to the base, the first body has a second end at which a third coupling is affixed;
a work implement having a fourth coupling that releasably mates with the third coupling to secure the work implement to the first shaft, wherein the fourth coupling also releasably mates with the first coupling; and
a second shaft with an elongated, flexible second body comprising a metal core with an exterior coating, the first shaft having one end at which is affixed a fifth coupling that releasably mates with third coupling to attach the second shaft to the first shaft, the second body has another end at which is affixed a sixth coupling that releasably mates with the fourth coupling to attach the work implement to the second shaft.

12. The work implement holder as recited in claim 11 wherein the metal core is composed of metal selected from the group consisting of lead, zinc, copper, aluminum, iron, steel, and alloys thereof.

13. The work implement holder as recited in claim 11 wherein the exterior coating is composed of a material selected from the group consisting of plastic, rubber, and polymer foam.

14. The work implement holder as recited in claim 11 wherein the first, third and sixth couplings have an aperture; and the second, fourth and fifth couplings have a shank that is receivable in the aperture.

15. The work implement holder as recited in claim 11 wherein the second, fourth and fifth couplings have an aperture; and the first, third and sixth couplings have a shank that is receivable in the aperture.

16. The work implement holder as recited in claim 11 wherein the work implement is one of a mirror, a magnifying glass, a clip, and a permanent magnet.

17. The work implement holder as recited in claim 11 wherein the work implement has a threaded shaft for attaching an object thereto.

18. The work implement holder as recited in claim 11 further comprising a disk mounted to the first coupling and spaced from the permanent magnet.
